(19) United States
(12) Patent Application Publication
(10) Pub. No.: US 2015/0133575 A1
(43) Pub. Date: May 14, 2015

(54) PROCESS FOR THE POLYMERISATION OF ETHYLENE

(71) Applicant: SAUDI BASIC INDUSTRIES CORPORATION, Riyadh (SA)

(72) Inventors: Nicolaas Hendrika Friederichs, Brunssum (NL); Remy Peter Theresia Smeets, Brunssum (NL); Matthijs van Kessel, Oirsbeek (NL)

(21) Appl. No.: 14/395,007

(22) PCT Filed: Apr. 22, 2013
(86) PCT No.: PCT/EP2013/001191

§ 371 Date: Oct. 16, 2014

(30) Foreign Application Priority Data
Apr. 26, 2012 (EP) 12002933.5

(51) Int. Cl. C08F 210/16

(52) U.S. Cl. CPC C08F 210/16
USPC 521/144; 526/124.5; 526/348.6

(57) ABSTRACT

The invention relates to a process for the production of polyethylene. The polymerisation takes place in the presence of a catalyst system comprising a hydrocarbon solution containing 1) a dialkoxy magnesium compound and 2) an organic oxygen containing titanium compound further comprising an inorganic oxide support and an activator.

### CROSS REFERENCE TO RELATED APPLICATIONS

This application is a 371 of International Application No. PCT/EP2013/001191, filed Apr. 22, 2014, which claims priority to European Application No. 12002933.5, filed Apr. 26, 2012, both of which are hereby incorporated by reference in its entirety.

The present invention relates to a process for the production of polyethylene in the presence of a Ziegler-Natta catalyst system and the use of the obtained polyethylene in blow moulding applications.

Polyethylenes are commercially produced using free-radical initiators, Ziegler-Natta catalysts, chromium oxide (Phillips type) catalysts, and metallocene or single-site catalysts. The Ziegler-Natta catalyst is a complex formed by reaction of a transition metal compound (halide, alkoxide, alkyl or aryl derivative) of Group IV-VIII transition metals with a metal alkyl halide of Group I-III base metals. Ziegler-Natta catalysts are based on titanium salts and aluminium alkyls. A Phillips catalyst is based on chromium (VI) oxide supported on silica or aluminosilicate. Unlike the Ziegler-Natta catalysts it does not necessarily require a co-catalyst to be activated in polymerisation. Activation is carried out by heat treatment in the presence of oxygen. Due to their multi-sited nature, Ziegler-Natta and chromium catalysts produce structurally heterogeneous ethylene homo- and copolymers. This means that the polymers have relatively broad molecular weight distribution (MWD or M_{w}/Mₙ) and broad composition (short chain branching) distribution. Catalyst active sites that produce lower molecular weights also have a tendency to incorporate more comonomer and as a result there is an additional compositional drift, with shorter polymer chains containing most of the comonomer and the longer chains being more linear. In a two-stage process, the low and high molecular fractions are produced in different reactors and therefore their comonomer contents can be easily controlled by the amount of comonomer fed into each reactor.

According to Knuuttila et al (Advanced Polyethylene Technologies; Adv. Polymer science (2004) 169:13-27) the molecular weight distribution (MWD) of a single site catalyst is about 2, the MWD of a Ziegler-Natta catalyst is about 4-6 and the MWD of a chromium based catalyst is higher than 7.

Polyethylene has been used in the production of blow molded products, such as bottles. The blow molding process is performed by extruding molten polyethylene as a parison or hollow tube into a mold cavity while simultaneously forcing air into the parison so that the parison expands, taking on the shape of the mold. The molten polyethylene cools within the mold until it solidifies to produce the desired molded product. During blow molding, the polyethylene will expand or swell upon exiting the die of the extruder. An important property for blow moulding is the melt strength of the polymer. Certain melt strength is necessary to prevent melt fracture and shark skin during blow moulding. On the other hand, one must avoid a too high melt elasticity caused by a too high fraction of high molar mass material as this can cause problems in cutting off the parison. This means the melt strength of the polymer must not be too low but neither too high. Generally, chromium catalysts produce a relatively broader MWD in comparison to Ziegler/Natta catalysts. Therefore chromium catalysts are applied for blow moulding applications. Ziegler-Natta produced polyethylene resins used in blow molding resins are typically bimodal resins wherein a low molecular weight polymer and a high molecular weight polymer are combined to provide a broad molecular weight distribution to improve the melt properties of the resin.

By “Melt Flow Rate” or abbreviated “MFR” is meant the weight of a polymer extruded through a standard cylindrical die at standard temperature in a melt indexer carrying a standard piston and load. MFR is a measure of the melt viscosity of a polymer and hence also of its molar mass. The abbreviation “MFR” is generally provided with a numerical sub index indicating the load of the piston in the test. Thus, e.g., MFR₂ designates a 2.16 kg load and MFR₂₁ a load of 21.6 kg. MFR can be determined using, e.g., by one of the following tests: ISO 1133 C4, ASTM D 1238 and DIN 53735.

By “Flow Rate Ratio” or abbreviated FRR is meant a ratio between two MFR values measured from the same polymer using different loads. The abbreviation FRR is generally provided with a subindex indicating which loads have been used to determine the FRR. Thus FRR_{21/2} has been obtained as a ratio of MFR₂₁ to MFR₂. As described a.o. by Shida in Polymer Engineering and Science, March 1971, vol 11, no 2, page 124-128, the FRR is a measure of the rheological broadness of a material. A high FRR corresponds to a so called high shear thinning behavior, caused by a broad MWD and/or the presence of long chain branching. For Ziegler catalysts, a high FRR corresponds in general to a broad MWD. For certain application, like blow moulding, a high FRR is wanted

For particle forming processes, like gasphase and slurry polymerization processes, the bulk density of the as formed polymer powder is very important because the bulk density has influence on the maximum throughput in the reactor. If the bulk density is too low this will result in throughput limitations in the polymerization reactor.

It is the object of the present invention to provide a high activity Ziegler Natta based catalyst for the polymerization of ethylene which results in a unimodal polyethylene having a FRR _{21/2} higher than 33 but lower than 50 when used in a single reactor wherein the characteristics of the polyethylene have the desired values for blow moulding applications and the bulk density of the polymer is at least 400 grams/m³.

The polymerisation of ethylene according to the present invention takes place in the presence of a catalyst system comprising a hydrocarbon solution containing
1) a dialkoxy magnesium compound and
2) an organic oxygen containing titanium compound further comprising an inorganic oxide support and an activator.

The inorganic oxide support is a silica support with hydroxyl groups on the surface. The silica support is porous.

The characteristics of suitable silica supports are disclosed at pages 394-401 in “Silica-Based Ziegler-Natta Catalysts: A Patent Review,” (Science and Engineering, Thomas Pullukat and Raymond Hoff (1999): Catalysis Reviews: Science and Engineering, 41:3-4, 389-428).

Preferably the silica has a surface area (SA) between 200 and 700 m²/g, a pore volume (PV) between 1.0 and 3.2 ml/g and a D₅₀ ranging between 20 and 150 micrometers.

Suitable dialkoxy magnesium compounds include for example magnesium alkoxides such as magnesium methylate, magnesium ethylate and magnesium isopropylate. Preferably the magnesium alkoxide is magnesium ethoxide (Mg(OC₂H₅)₂.)

Suitable organic oxygen containing titanium compound may be represented by the general formula [TiOₓ (OR)₄₋₂ₓ]ₙ in which R represents an organic radical, x ranges between 0 and 1 and n ranges between 1 and 6.

Suitable examples of organic oxygen containing titanium compounds include alkoxides, phenoxides, oxyalkoxides, condensed alkoxides, carboxylates and enolates. Preferably the organic oxygen containing titanium compounds is a titanium alkoxide.

Suitable alkoxides include for example Ti (OC₂H₅)₄, Ti (OC₃H₇)₄, TiOC₄H₉)₄ and Ti(OC₈H₁₇)₄. Preferably the organic oxygen containing titanium compound is Ti (OC₄H₉)₄.

The catalyst system comprises an activator. Preferably the activator is an aluminium halogenide having the formula AlRₙX₃₋ₙ in which R is a hydrocarbon radical containing 1-10 carbon atoms, X is halogen and 0<n<3.

According to a preferred embodiment X is Cl.

According to a preferred embodiment 1.5<n<3.

Suitable examples of these aluminium halogenides include aluminium ethyl aluminium dibromide, ethyl aluminium dichloride, propyl aluminium dichloride, n-butyl aluminium dichloride, iso butyl aluminium dichloride, diethyl aluminium chloride, diisobutyl aluminium chloride. Preferably the organo aluminium halogenide is ethyl aluminium dichloride.

The hydrocarbon solution of organic oxygen containing magnesium compound and organic oxygen containing titanium compound can be prepared according to procedures as disclosed for example in U.S. Pat. No. 4,178,300 and EP0876318. The solutions are in general clear liquids. In case there are any solid particles, these can be removed via filtration prior to the use of the solution in the catalyst synthesis.

The catalyst may be obtained by a first reaction between a magnesium alkoxide and a titanium alkoxide, followed by dilution with a hydrocarbon solvent, for example hexane, resulting in a soluble complex consisting of a magnesium alkoxide and a titanium alkoxide. This complex is added to the inorganic support, for example silica. Next the silica is washed with the hydrocarbon solvent. During the washing step the titanium which is not attached to the inorganic support is removed which means that the amount of titanium in the hydrocarbon solution is different from the amount of titanium on the inorganic support such as silica.

Thereafter the solvent is evaporated. In the following step a reaction between the complex on silica and the activator, preferably organo aluminium halogenide having the formula AlRₙX₃₋ₙ, takes place. Following steps are the washing steps to remove the excess of activator and the evaporation of the solvent.

Generally, the aluminium halogenide having the formula AlRₙX₃₋ₙ is used as a solution in a hydrocarbon.

Any hydrocarbon that does not react with the organo aluminium halogenide is suitable to be applied as the hydrocarbon solvent in the foregoing procedure.

The temperature for said reaction with the activator may be any temperature below the boiling point of the used hydrocarbon. Generally the duration of the addition is shorter than 1 hour.

Generally the molar ratio of aluminium from aluminium halogenide having the formula AlRₙX₃₋ₙ:titanium on the inorganic support ranges between 4:1 and 40:1. Preferably this ratio ranges between 8:1 and 30:1. Preferably this ratio ranges between 10:1 and 25:1.

This ratio is important because with varying this ratio the FRR can be influenced.

During the polymerization of ethylene a cocatalyst may be present. According to a preferred embodiment of the invention the cocatalyst is an aluminium compound having the formula AlR₃ in which R is a hydrocarbon radical containing 1-10 carbon atoms. Suitable examples of this cocatalyst include tri ethyl aluminium, tri isobutyl aluminium, tri-n-hexyl aluminium and tri octyl aluminium. Preferably the aluminum compound is tri ethyl aluminium or tri isobutyl aluminium.

Generally the molar ratio of aluminium from the co catalyst:titanium from the organic oxygen containing titanium compound ranges between 1:1 and 300:1 and preferably this molar ratio ranges between 3:1 and 100:1.

The catalyst according to the present invention may be used in homo- or co-polymerisations of ethylene. Preferably the polyethylene is high density polyethylene (HDPE). Ethylene or mixtures of ethylene with C₃ to C₈ [alpha]-alkenes may be used in the polymerisations.

The ethylene polymerisation process may take place via slurry process, via a gas phase process or via a solution process.

Preferably the process takes place via the slurry phase polymerisation process. The slurry polymerisation process is disclosed for example in “Handbook of Polyethylenes” by Andrew Peacock, 2000, pages 61-66.

Preferably, the polymerization of ethylene takes place in a diluent at a temperature of between 80° C. and 110° C. Hydrogen can be used in the polymerization process of the present invention for example to control melt flow index, die swell as well as elasticity of the polymer products. Suitable diluents include paraffins, cycloparaffins and/or aromatic hydrocarbons such as for example isobutane and propane. An anti-static agent can be used to suppress fouling of the polymerization reactor wall. Examples of suitable anti-static agents are disclosed in U.S. Pat. No. 4,182,810, EP107127 A1 or Research Disclosure 515018.

The ethylene polymerisation process in a single reactor with the catalyst according to the invention results in polyethylene having the following characteristics:
M_{w}/Mₙ≧6 and ≦12 (according to size exclusion chromatography (SEC) measurement)
density≧945 kg/m³ and ≦962 kg/m³ (according to IS01183) and
a Melt Flow Rate (MFR) from 0.5 to 10 g/10 min (at 190° C. and 2.16 kg measured according to ISO 1872-1) and
FRR_{21/2} in the range of 33-50.

According to a preferred embodiment of the invention the catalyst system produces polyethylene having M_{w}/Mₙ≧6 and ≦10.

These polyethylenes obtained with the Ziegler Natta catalyst according to the invention are very suitable to be applied in blow moulding applications such as the production small bottles and small cans for example less than 5 litres because they show the required melt flow properties and melt strength values.

The ethylene polymers or copolymers obtained with the process according to the invention may be combined with additives such as for example lubricants, fillers, stabilizers, antioxidants, compatibilizers and pigments. The additives used to stabilize the copolymers may be, for example, additive packages including hindered phenols, phosphites, UV stabilisers, antistatics and stearates.

WO92/13009 discloses a supported transition metal catalyst component which comprises an inert liquid medium having slurried therein a composition comprising the product resulting from contacting a porous solid inorganic oxide support material selected from the group consisting of silica, alumina, or a combination of silica and alumina having a particle size D₅₀ not greater than 10 microns; a hydrocarbon soluble organomagnesium alkoxide or hydrocarbon soluble organomagnesium dialkoxide; a titanium compound; a vanadium compound and a Group IIIA metal alkyl halide. The vanadium containing catalysts produce a polymer having a relatively broad molecular weight distribution when the polymers are prepared by the slurry process. Example 9 shows that high I₂₀/I₂ ratios (FRR) in the range between 57.8 and 60.0 can be achieved with the vanadium containing catalysts in slurry polymerizations. These high ratio's indicate a broad molecular weight distribution.

WO9400498 is directed to a process for preparing a procatalyst composition suitable for the polymerization of ethylene which comprises the steps of contacting an inorganic oxide carrier, having a low content of surface hydroxyls, with an impregnation solution containing a magnesium compound, an alcohol, and a tetravalent titanium compound, chlorinating the inorganic oxide carrier with a chlorinating agent and recovering the contacted and chlorinated product to yield the procatalyst. The impregnation solution comprises a magnesium alkoxide, a titanium alkoxide and a lower alcohol. The carrier is an inorganic oxide, from which the surface hydroxyls have been removed. FRR_{21/2} is less than 30. The present invention is different because the catalyst according the present invention does not comprise a lower alcohol. Furthermore the inorganic silica support applied in the present invention is an inorganic support with hydroxyl groups on the surface.

EP 604850 discloses a method for preparing a procatalyst composition for the polymerization of olefins in steps comprising contacting of a particulate inorganic support with a chlorinating agent and further contacting it with an impregnating solution based on a magnesium compound, a tetravalent titanium compound and an electron donor, characterized in that it includes the following steps:
a) contacting the particulate inorganic support with a chlorinating agent,
b) impregnating the particulate inorganic support with a solution based on (i) a magnesium halide, (ii) a magnesium alkoxy compound, (iii) a tetravalent titanium alkoxide compound and (iv) an electron donor. The products obtained are not suitable to be applied in blow molding application because the FRR is lower than 31.1. The catalyst applied in the present invention does not comprise an electron donor, a magnesium halide and a chlorinating agent.

EP 688794 discloses a procatalyst for the production of ethylene polymers, which procatalyst comprises an inorganic support, a chlorine compound carried on said support, a magnesium compound carried on said support, a titanium compound carried on said support, whereby the chlorine compound can be different from or the same as the magnesium compound and/or the titanium compound. FRR_{21/2} is less than 31.

The invention will be elucidated by means of the following non-restrictive experiments and examples.

### Experiment I: Preparation of a Hydrocarbon Solution Comprising the Organic Oxygen Containing Magnesium Compound and the Organic Oxygen Containing Titanium Compound

To a 2 L round bottom flask equipped with a dropping funnel and a water cooler, 101 grams of Mg(OEt)₂ (0.883 mol) and 150 mL Ti(OBu)₄ (0.0.441 mol) was added. 1500 mL of hexanes was put in the dropping funnel. The mixture was then heated at a temperature of 180° C. and stirred (300 rpm) till all the Mg(OEt)₂ was dissolved in the Ti(OBu)₄. The mixture was cooled down till it reached 120° C. To prevent the mixture of becoming too viscous, the hexanes solvent was added slowly at the temperature of 120° C. When all the hexanes solvent was added, the mixture was cooled down to room temperature. A 20 wt % solution with a Mg/Ti ratio of 2 was obtained.

### Experiment II: Pre-Treatment Silica

The silica (ES70X of PQ) to be used in the preparation of the catalyst was first calcinated in a fluidized bed oven. The silica was heated under N₂ from room temperature to 600° C. The temperature remained at 600° C. for 4 hours. After the 4 hours of heating, the silica was cooled down to room temperature.

### EXAMPLE I

### Catalyst Preparation

### Hydrocarbon Solution on Silica

The synthesis was started with 50 grams of silica according to Experiment II. An amount of solution according to Experiment I was added to have 1.5 mmol magnesium/1 gram of silica. A round bottom flask equipped with a water cooler was filled with 1050 grams of silica, 134 mL solution (1.95 wt %, 76 mmol Mg; 1.7 wt %, 35 mmol Ti) and 250 mL hexanes solvent. The reaction mixture was stirred (200 rpm) for 2 hours (reaction time) at a temperature of 80° C. After the 5 hours, the reaction mixture was cooled down to room temperature. The silica was washed 5 times with hexanes. The excess of magnesium and titanium were hereby washed away to prevent the formation of active catalyst particles which were not on the silica surface. After the washing step the silica was dried at a temperature of 50° C., nitrogen flushed.

TABLE A

| Mg (wt %) | Ti (wt %) |
|---|---|
| 2.13 | 1.35 |

Inductive Coupled Plasma was used for determining concentrations of elements as shown in Table A.

### Addition of Activator

A round bottom flask with 50 grams of the solution on silica obtained above equipped with a water cooler and a dropping funnel, was filled with 250 mL hexanes solvent. The dropping funnel was filled with 50 mL hexanes solvent and 100.8 mL 50% ethyl aluminium dichloride (EADC) (0.342 mol) (Al/Ti ratio of 25). The EADC was slowly added to the reaction mixture at room temperature. While adding the EADC, the reaction mixture turned brown. After everything was added the mixture was heated for 2 hours at 80° C. While heating, the mixture turned from brown to black. After the 2 hours, the mixture was cooled down to room temperature. The silica was washed 4 times with hexanes solvent. The washing step removed the excess EADC. After the washing step, the silica was dried at a temperature of 50° C., nitrogen flushed. The dried silica had a brown colour.

TABLE B

| Al (wt %) | Mg (wt %) | Ti (wt %) | Cl (wt %) |
|---|---|---|---|
| 4.6 | 1.77 | 1.24 | 16.2 |

Neutron activation analysis (NAA-analysis) was used for determining concentrations of elements as shown in Table B.

### EXAMPLE II

### Polymerization

Ethylene and 1-butene were copolymerized in a continuously operated 5 L liquid-filled CSTR reactor in isobutene at 4.6 MPa in the presence of catalyst according to Example I. The catalyst contained 1.24 wt % of titanium and 1.77 wt % of magnesium.

Triisobutyaluminium (TiBA) was used as a promoter.

Isobutane (2.890 kg/h), ethylene (1.290 kg/h), 1-butene (21.0 g/h) and hydrogen (0.98 g/h) were continuously fed to the reactor at 98° C. TiBA was also continuously fed to the reactor in such an amount that concentration of aluminium was 10 ppm.

The catalyst feed to the reactor was controlled in order to maintain a constant ethylene concentration in the reactor of 10 mol %.

Polyethylene production was 1.0 kg/h.

The activity was 4650 g of polyethylene per g of catalyst.

After stabilization, the polymer reactor powder was pelletized in a twin-screw extruder.

The polyethylene pellets had the following characteristics:
Density: 952.4 kg/m³
MFI_{2.16}: 2.10 g/10 min
MF _{21.6}: 67.1 g/10 min
FRR_{21/2}: 33.2
Mw/Mn: 6.8
Cat yield: 4650 g/g
Bulk density: 426 kg/m³

### COMPARATIVE EXAMPLE A

### Preparation Catalyst

First, 300 grams of silica type ES70X was added to a three necked flask equipped with a stirrer and a dropping funnel. Using the dropping funnel, 45 grams of hexamethyl disilazane (HMDS) (=15 wt %) was added over a period of 30-45 minutes. Heat formation and odour of ammonia were noticed. After the addition of HMDS the mixture was left to age for 3 weeks at room temperature in order to complete the reaction, after which the silica was dried using a fluidized bed reactor at a temperature of 150° C. for a period of 6 hours and stored under nitrogen atmosphere.

To a 1 L three necked flask, equipped with a dosing funnel, a cooler and a paddle stirrer, as shown in FIG. 12. 25 grams of HMDS treated silica and 150 mL of dried heptanes were added. While stirring at 200 rounds per minute, 21.5 mL (26 mmol) of dibutyl magnesium was added at room temperature over a period of 1 hour using the dosing funnel. The reaction mixture was aged for another hour. During the next step, a mixture of 2.5 mL 1-butanol (27 mmol) and 30 mL of heptanes were added using the dropping funnel over a period of 1 hour at room temperature. The reaction mixture was left to age for another hour. Next, a mixture of 3.1 mL of TiCl₄ (28.8 mmol) and 30 mL of heptanes was added using the dropping funnel over a period of 1 hour at room temperature. The colour of the reaction mixture changed during the addition of TiCl₄.

The reaction mixture was refluxed for approximately 2 hours at 95° C. and stored under nitrogen atmosphere overnight. The heptanes were removed by flashing nitrogen for approximately 2.5 hours at 105° C. Vacuum was applied to the flask at 50° C. for another hour to remove any last traces of heptanes. The catalyst obtained (red-brown color) was transferred to a 250 mL three necked flask for storage.

### COMPARATIVE EXAMPLE B

### Polymerization

Ethylene and 1-butene were copolymerized in a continuously operated 5 L liquid-filled CSTR reactor in isobutene at 4.6 MPa in the presence of commercial catalyst on ES70X silica support. The catalyst contained 3.79 wt % of titanium and 1.95 wt % of magnesium.

Triisobutyaluminium (TiBA) was used as a promoter.

Isobutane (2.903 kg/h), ethylene (1.292 kg/h), 1-butene (41.1 g/h) and hydrogen (0.55 g/h) were continuously fed to the reactor at 98° C. TiBA was also continuously fed to the reactor in such an amount that concentration of aluminium was 10 ppm.

The catalyst feed to the reactor was controlled in order to maintain a constant ethylene concentration in the reactor of 10 mol %.

Polyethylene production was 1.0 kg/h.

The activity was 4600 g of polyethylene per g of catalyst.

After stabilization, the polymer reactor powder was pelletized in a twin-screw extruder.

The polyethylene pellets had the following characteristics:
Density: 951.9 kg/m³
MFI_{2.16}: 2.21 g/10 min
MF_{21.6}: 60.2 g/10 min
FRR_{21/2}: 27.2
Mw/Mn: 4.8
Cat yield: 4600 g/g
Bulk density: 445 kg/m³

The FRR_{21/2} and the Mw/Mn of the polymer made according to Example II were improved when compared with the product according to the Comparative Experiment. Both materials were tested at a blow molding machine for production of 1 L bottles. The conclusion of the blow molding test was that the product produced with the polymer according to Example II could be used for production of excellent blow molded bottles without any melt fraction whereas no bottles could be blown from the product obtained with the Comparative Experiment because of melt fraction.

1. A process for the production of polyethylene, comprising;
polymerizing in the presence of a catalyst system to produce the polyethylene,
wherein the catalyst system comprises a hydrocarbon solution containing
1) a dialkoxy magnesium compound and
2) an organic oxygen containing titanium compound further comprising an inorganic oxide support and an activator.

2. The process according to claim 1, wherein the inorganic oxide support is silica having a surface area (SA) between 200 and 700 m²/g, a pore volume (PV) between 1.0 and 3.2 ml/g and a D₅₀ ranging between 20 and 150 micrometers.

3. The process according to claim 1, wherein the dialkoxy magnesium compound is magnesium ethoxide.

4. The process according to claim 1, wherein the organic oxygen containing titanium compound is titanium alkoxide.

5. The process according to claim 1, wherein the activator is an aluminium halogenide having the formula AlRₙX₃₋ₙ in which R is a hydrocarbon radical containing 1-10 carbon atoms , X is halogen and 0<n<3.

6. The process according to claim 1, wherein a molar ratio of aluminium from aluminium halogenide having the formula AlRₙX₃₋ₙ:titanium on the inorganic support ranges between 4:1 and 40:1.

7. The process according to claim 6 wherein the molar ratio ranges between 8:1 and 30:1.

8. The process according to claim 1, wherein the polymerisation process is a slurry polymerisation process.

9. The process according to claim 1, wherein the process takes place in a single reactor resulting a polyethylene having the following characteristics:
M_{w}/Mₙ≧6 and ≦12 (according to size exclusion chromatography (SEC) measurement)
density≧945 kg/m³ and ≦962 kg/m³ (according to IS01183) and
a Melt Flow Rate (MFR) from 0.5 to 10 g/10 min (at 190° C. and 2.16 kg measured according to ISO 1872 1) and
FRR_{21/2} in the range of 33-50.

10. A blow molded article prepared using the products obtained with the process according to claim 1.

11. Bottles and cans with a volume lower than 5 litres prepared using the products obtained with the process according to claim 1.

12. The process of claim 1, wherein ethylene is used in the polymerization.

13. The process of claim 12, further comprising using C₃ to C₈ [alpha]-alkenes may in the polymerisation.
